(19) United States
(12) Patent Application Publication
(10) Pub. No.: US 2010/0006803 A1
(43) Pub. Date: Jan. 14, 2010

(54) METHOD OF TREATING A HIGH-PRESSURE HYDROCARBON STREAM HAVING A HIGH CARBON DIOXIDE CONTENT TO YIELD A HIGH PURITY HYDROCARBON GAS STREAM AND A SEQUESTRATION READY CARBON DIOXIDE GAS STREAM

(76) Inventors: Jose Luis Bravo, Houston, TX (US); Ashok Kumar Rupkrishen Dewan, Sugar Land, TX (US); Raymond Nicholas French, Sugar Land, TX (US); Amrit Lal Kalra, Sugar Land, TX (US); Pervaiz Nasir, Sugar Land, TX (US); Jiri Peter Thomas Van Straelen, Amsterdam (NL)

Correspondence Address: SHELL OIL COMPANY, P O BOX 2463, HOUSTON, TX, 772522463, US

(21) Appl. No.: 12/500,352

(22) Filed: Jul. 9, 2009

Related U.S. Application Data
(60) Provisional application No. 61/079,740, filed on Jul. 10, 2008.
(60) Provisional application No. 61/180,304, filed on May 21, 2009.

(51) Int. Cl. B01D 53/14

(52) U.S. Cl. 252/372

(57) ABSTRACT

A method of treating a high-pressure hydrocarbon stream, such as natural or synthetic gas, contaminated with a high concentration of carbon dioxide, by contacting the contaminated high-pressure hydrocarbon stream with a chilled aqueous ammonia solution in an absorber at high pressure to produce a treated gas stream having a substantially reduced carbon dioxide content and a carbon dioxide-rich ammonia solution. The carbon dioxide-rich ammonia solution is regenerated by stripping, thus producing a concentrated carbon dioxide stream at high pressure suitable for sequestration or other uses.

This application claims the benefit of U.S. Provisional Application No. 61/079,740 filed Jul. 10, 2008, and U.S. Provisional Application No. 61/180,304 filed May 21, 2009, the entire disclosures of which are hereby incorporated by reference.

The invention relates to a method of treating a high-pressure hydrocarbon stream having a high concentration of carbon dioxide and some hydrogen sulfide to remove carbon dioxide and hydrogen sulfide therefrom and to yield a treated gas stream and a carbon dioxide-rich stream.

There are numerous sources of hydrocarbon gas that contain such significant concentrations of carbon dioxide that the gas from these sources is unsuitable for uses such as the introduction into pipelines for sale and delivery to end-users. Among these sources is gas from natural gas reservoirs that may have such high concentrations of carbon dioxide that conventional methods of removing the carbon dioxide are not economical or even technically feasible, thus, making these reservoirs non-producible. Also, with recent concerns over the release of greenhouse gases into the atmosphere, the separation of large volumes of carbon dioxide from natural gas streams containing large concentrations of carbon dioxide can be problematic.

The prior art describes past efforts to find ways of removing small concentrations of carbon dioxide from sour natural gas. For instance, U.S. Pat. No. 3,524,722 discloses a method of removing carbon dioxide from natural gas by chemically reacting the carbon dioxide with liquid ammonia to thereby form solid ammonium carbamate. The '722 patent teaches that, in its process, natural gas is bubbled through liquid ammonia contained in a reactor vessel in which the carbon dioxide reacts with the ammonia to form solid ammonium carbamate, which settles to the bottom of the reactor vessel. A slurry is removed from the reactor vessel and is passed to a converter by which the ammonium carbamate is converted to urea in accordance with the following reaction formula: NH₂CO₂NH₄→(NH₂)₂CO+H₂O. The natural gas stream to be purified can be at a relatively high pressure, but there is no suggestion in the '722 patent that the gas streams to be treated may have excessively high concentrations of carbon dioxide. It is also noted that the process taught does not use aqueous ammonia and that the carbon dioxide is ultimately removed in the form of a urea reaction product.

U.S. Pat. No. 4,436,707 discloses a process for removing acid gases, such as carbon dioxide and hydrogen sulfide, from natural gas streams by the use of a methanol washing liquid that contains ammonia. The amount of ammonia contained in the methanol is greater than 0.5 weight percent and should be sufficient to prevent the formation of solid precipitates. The '707 patent teaches an ammonia content in its methanol solvent stream that is, in effect, a relatively low amount (37 Ncm³/ml, i.e., 3.5 weight percent), thus, the methanol essentially serves as the solvent for the ammonia. There is no teaching in the '707 patent of the processing of a high pressure natural gas stream that has a high concentration of carbon dioxide, e.g., substantially greater than 3.5 volume percent CO₂, to yield a treated gas stream suitable for introduction into pipelines for sale and delivery to end-users and to yield a carbon dioxide gas stream at such a purity and pressure condition that it is suitable for sequestration. It is noted that the '707 patent does not teach the use an aqueous-based solvent.

The process disclosed in WO 2006/022885 is directed to a system or method of cleaning, downstream of a conventional air pollution control system, a combustion gas stream of residual contaminants by the use of an ammoniated solution or slurry in a NH₃—CO₂—H₂O system and of capturing CO₂ from the combustion gas stream for sequestration in concentrated form and at high pressure. The publication does not teach a process for the treatment of a high-pressure hydrocarbon stream having a high concentration of CO₂ under high pressure absorption conditions. Rather, the publication notes that the CO₂ concentration of the combustion gas, which contains essentially no hydrocarbons or hydrogen sulfide due to the combustion, is typically 10-15% for coal combustion and 3-4% for natural gas combustion. The disclosed process further involves conducting the absorption step at low temperature and low pressure (about atmospheric pressure) with the absorbent regeneration being conducted at high-pressure conditions. This pressure difference requires the process to utilize a high-pressure pump in order to allow for the regenerator to operate at high pressure.

Thus, there remains a need in the art for a method to treat high-pressure hydrocarbon streams contaminated with large concentrations of carbon dioxide in order to produce a marketable clean treated gas and a concentrated stream of carbon dioxide that is sequestration ready, or which can be used for other purposes.

The present invention provides a highly effective and cost efficient method for treating a high-pressure hydrocarbon stream contaminated with a high concentration of carbon dioxide to produce a treated hydrocarbon gas stream, and a concentrated stream of carbon dioxide at high pressure suitable for sequestration or other uses. The method of the invention involves contacting the contaminated high-pressure hydrocarbon gas stream with a chilled ammonia solution in an absorber at a high pressure to produce a treated hydrocarbon stream and a carbon dioxide rich-ammonia solution. The carbon dioxide-rich ammonia solution is regenerated at high pressure in a stripping column producing a concentrated stream of carbon dioxide at high pressure and a lean ammonia solution.

The treated hydrocarbon gas stream, with optional further treatment, can be suitably introduced into pipelines for sale and delivery, while the high-pressure concentrated carbon dioxide-rich stream can be suitably sequestered or used for other purposes such as enhanced oil recovery, super-critical solvent, etc. The lean ammonia solution can be cooled by heat exchange with the carbon dioxide-rich ammonia solution and subsequently recycled to the absorber.

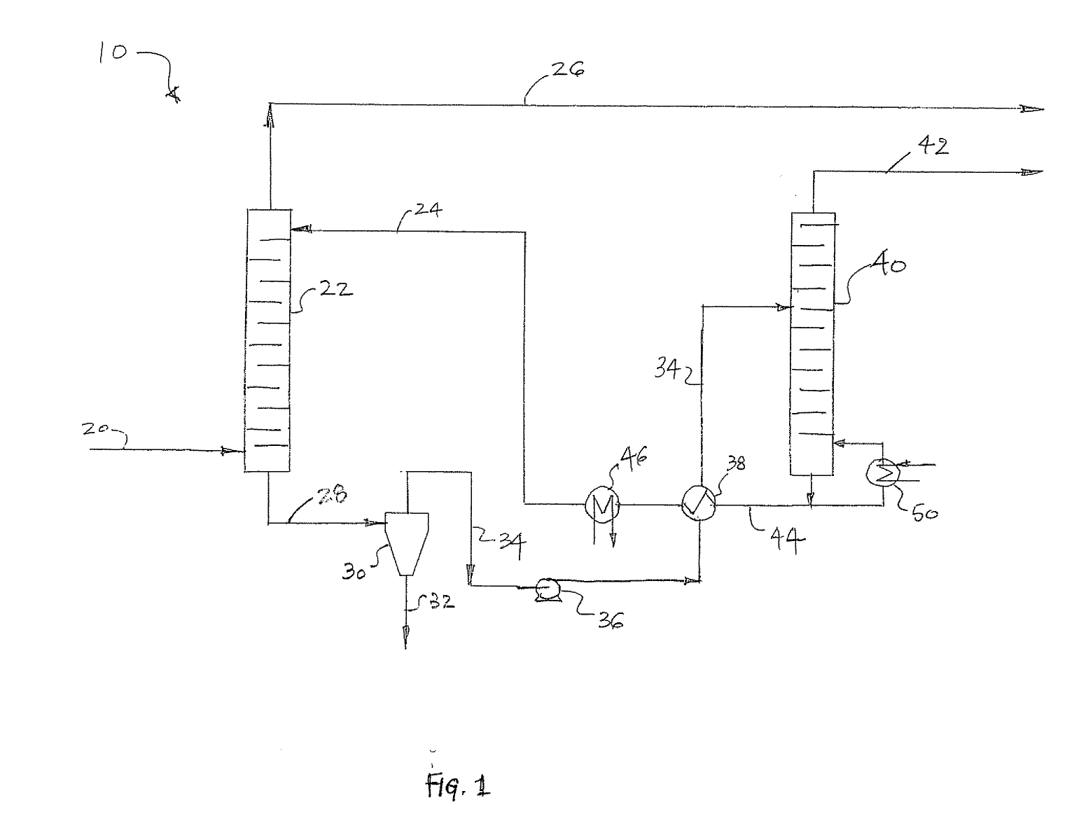

FIG. 1 is a process flow diagram showing one embodiment of the present invention.

The present method is particularly effective in removing carbon dioxide from high-pressure hydrocarbon gas streams contaminated with relatively high concentrations of carbon dioxide that can exceed 5 vol. % of such a hydrocarbon gas stream, e.g. the high concentration of carbon dioxide can be in the range of from 5 vol. % to 80 vol. % carbon dioxide, more typically, from 8 vol. % to 60 vol. %, and, most typically, from 10 vol. % to 40 vol. %.

The high-pressure hydrocarbon stream may in some cases also be contaminated with a concentration of hydrogen sulfide, e.g., in the range of from 0.5 vol. % to 20 vol. % hydrogen sulfide, or of from 1 vol. % to 15 vol. % hydrogen sulfide.

The present method is effective in removing both carbon dioxide and hydrogen sulfide from such contaminated high-pressure hydrocarbon streams.

An example of a high-pressure hydrocarbon stream which is particularly suitable for treatment in accordance with the present method is natural gas, which typically is produced at high pressures, e.g., from 10 barg to 100 barg, more typically from 50 barg to 80 barg and frequently contains varying concentrations of carbon dioxide and also hydrogen sulfide. In fact, some natural gas reservoirs contain such large concentrations of carbon dioxide that they are considered commercially uneconomical.

The present method is particularly applicable to the treatment of natural gases having large concentrations of carbon dioxide and hydrogen sulfide, as in the aforementioned ranges, which were heretofore considered to be uneconomical and/or impractical to produce. As is typical for these natural gas sources that are highly contaminated with carbon dioxide and, optionally, hydrogen sulfide, they contain one or more gaseous hydrocarbon components. The gaseous hydrocarbon components of these natural gas sources generally comprise, predominantly, methane, but they may further include hydrocarbons such as ethane, propane, butane, pentane and, even, trace amounts of heavier hydrocarbon compounds.

Thus, in addition to having a relatively high, if not exceedingly high, concentration of carbon dioxide, and, optionally, hydrogen sulfide, the highly contaminated high-pressure gas stream, or natural gas stream, of the inventive process can contain upwardly to or about 95 vol. % methane. Thus, methane can be present in the range of from 5 vol. % to 95 vol. % of the gas stream. But, more typically, the methane content is in the range of from 40 vol. % to 92 vol. %, and, most typically, from 60 vol. % to 90 vol. %.

In addition to the methane component, other gaseous hydrocarbons, such as, C₂H₆, C₃H₈, C₄H10, and C₅H₁₂, may be present in the highly contaminated high-pressure gas stream, with each of the hydrocarbon compounds, either individually or in combination, being present in the concentration range of upwardly to or about 20 vol. %, typically, from 0.1 vol. % to 15 vol. %, and, more typically, from 0.2 vol.% to 10 vol. %.

Also, small amounts of nitrogen and other inert gases, such as, Ar, He, Ne and Xe, may also be present but in relatively insignificant amounts with the nitrogen being present at a concentration of no more than 5 vol. %, and, more typically, less than 3 vol. %, but, most typically, less than 2 vol. %. The other inert gases, if present, are usually only present in small or trace amounts.

Other examples of high-pressure gas streams containing high concentrations of carbon dioxide and some hydrogen sulfide that can be treated in accordance with the present method are synthetic gases (for example from gasification or those generated during the production of unconventional oil from tar-sands or shale oils) that may contain up to 60% carbon dioxide.

In accordance with the present method, the contaminated high-pressure hydrocarbon gas stream is treated in an absorber with a chilled aqueous ammonia solution at a high pressure whereby most of the carbon dioxide, and hydrogen sulfide, if present, will be removed through reaction with a chilled ammonia solution yielding a treated hydrocarbon gas stream, having a substantially reduced carbon dioxide and hydrogen sulfide content relative to that of the contaminated high-pressure hydrocarbon gas stream, and a carbon dioxide-rich ammonia solution. The treated hydrocarbon gas stream may have a concentration of carbon dioxide of less than 3 vol. %, preferably, less than 2 vol. %, and, most preferably, less than 1.5 vol. %. The concentration of hydrogen sulfide, if present, of the treated hydrocarbon gas stream is less than 200 ppmv, and, preferably, less than 100 ppmv.

An important feature of the present invention is that the absorber is operated at high pressure, e.g., at a pressure of from 5 barg to 40 barg, and, preferably, from 10 barg to 20 barg. Operation of the absorber at these high pressures has been found to reduce the amount of chilling required for the ammonia solution, and it also reduces ammonia losses that can be a problem associated with low-pressure absorber operation. In addition, the reaction kinetics of ammonia pickup is significantly improved at the higher pressures. The improved reaction kinetics can also provide for capital savings by reducing equipment size requirements and other benefits.

The operating temperature in the absorber will generally range from 5° C. (degrees Celsius) to 60° C., with an operating temperature in the range from 10° C. to 40° C. being preferred.

The carbon dioxide-rich ammonia solution from the absorber is regenerated in a stripping column, which is operated at an elevated temperature and pressure. This results in the release of carbon dioxide (and any hydrogen sulfide, if present) from the carbon dioxide-rich ammonia solution, producing a concentrated carbon dioxide-rich stream at high pressure suitable for sequestration, and a lean ammonia solution that preferably is recycled to the absorber.

The concentrated carbon dioxide stream removed from the stripping column will generally have a high concentration of carbon dioxide, e.g., at least 90 vol. % CO₂, preferably, at least 92 vol. % CO₂, and it will be at a high pressure, e.g., above 5 barg, preferably from 25 barg to 50 barg, or higher. The fact that the present method yields a concentrated carbon dioxide stream at high pressure is a significant benefit, since one of the problems with many processes for making sequestration-ready carbon dioxide is that a compressor is required to compress the gas to the high pressures needed for storage. The operation of compressors to provide the high-pressure gas is very expensive and makes these processes uneconomical to operate.

The stripping column (also referred to herein as a “stripper” or “regenerator”) is normally operated at a higher pressure than that of the high-pressure absorber, and it also is operated at a considerably higher temperature. In general, the pressure in the stripper can range from 20 barg up to 100 barg, with a pressure in the range of from 25 to 50 barg being preferred. A particularly preferred range for the pressure in the stripper is from 30 barg to 40 barg. The temperature in the stripper can range from 40° C. up to 180° C., with a regeneration temperature in the range of 80° C. to 120° C. being preferred.

The ammonia solution used to treat the high-pressure hydrocarbon stream, having a high concentration of carbon dioxide, in accordance with the inventive method is an aqueous ammonia solution, having an ammonia concentration of from 1 to 50 wt % with the balance including water and, optionally, other components, such as, for example, certain reaction products that occur within the liquid NH₃—CO₂—H₂O system.

A preferred concentration of ammonia in the chilled aqueous ammonia solution is from 5 wt % to 35 wt %, with a more preferred ammonia concentration being in the range of from 10 wt % to 32 wt %, and, most preferred, from 12 wt % to 20 wt %. An especially desirable concentration for the ammonia in the aqueous ammonia solution is about 15 wt %, which, for example, is within the range of from or about 13 wt % to or about 17 wt %. The NH₃—CO₂—H₂O system reaction products that may be contained in the aqueous ammonia solution may include ammonium carbonate and ammonium bicarbonate. Preferably, these are in a dissolved state in the solution.

Another important feature of the invention is that the aqueous ammonia solution used to absorb the carbon dioxide is preferably chilled to a relatively low temperature, e.g., a temperature of less than 20° C., preferably less than 15° C., most preferably less than 10° C., prior to being contacted with the high-pressure hydrocarbon gas stream that is contaminated with a high concentration of carbon dioxide. Thus, suitable temperature ranges for the chilled aqueous ammonia solution are from 1° C. to 20° C., preferably from 3° C. to 15° C., and, most preferably, from 5° C. to 10° C. These are the temperatures at which the chilled ammonia is contacted with the high-pressure hydrocarbon gas stream fed into the absorber. It has been found that by utilizing chilled ammonia in the absorber and operating the absorber at a high pressure, it is possible to minimize ammonia losses while maintaining a high rate of carbon dioxide absorption in the absorber.

The high-pressure hydrocarbon gas stream is normally fed to the absorber at ambient temperature, but can be chilled to a lower temperature, if it is desired to operate the absorber at a lower temperature. However, since chilling adds to the cost of the process, it is generally preferred to chill only the aqueous ammonia solution, and to introduce the high-pressure hydrocarbon stream into the absorber at whatever temperature it is available (when possible, this hydrocarbon stream can be cooled by process heat integration). As long as the ammonia solution is chilled to the desired contact temperature, it is capable of absorbing the carbon dioxide (and hydrogen sulfide if present) from the high-pressure hydrocarbon gas feed stream.

In the present method, carbon dioxide contained in the high-pressure hydrocarbon feed stream is believed to be absorbed in the aqueous ammonia solution by several mechanisms, including reaction with carbonate ion to form bicarbonate ion. The carbonate ion is believed to be formed through at least one of a number of possible liquid phase reactions within the ammonia-carbon dioxide-water system. Hydrogen sulfide, if present, is believed to be removed according to the bisulfide reaction. The following reactions are believed to be involved in the present method, but should not be construed to in any way limit the invention:

CO₂ (aq)+CO₃²⁻ (aq)+H₂O→2 HCO₃⁻ (aq/s)

H₂S (aq)+OH⁻ (aq)→H₂O+HS⁻ (aq)

The above reactions are reversible, and the carbon dioxide and hydrogen sulfide are stripped from the liquid phase during regeneration in the stripping column/regenerator, which is operated at an elevated temperature and pressure.

The capacity of the aqueous ammonia solution to absorb carbon dioxide and the form in which the carbon dioxide is present (e.g., dissolved molecular CO₂, carbonate ion or bicarbonate ion) depends on the ammonia concentration, on the NH₃/CO₂ mole ratio and the temperature and pressure. It may also depend upon other chemical species that may be present such as H₂S, organic acids etc. that affect the pH of the aqueous stream and thus changes the dissolved CO₂ content in water.

It is preferred to operate the present absorption/regeneration method in liquid phase with minimum presence of suspended or precipitated solids. Thus, in a preferred embodiment of the present method, the above parameters are selected so that the carbon dioxide rich aqueous ammonia stream and the carbon dioxide lean aqueous ammonia stream are both in liquid phase with little or no solids present. Any solids that are generated during absorption phase are preferably removed using a filter, a cyclone or other separation means prior to being introduced into the stripper/regenerator.

While it is preferred to operate the present process in liquid phase and to minimize the amount of solids present in the aqueous ammonia solution, it is within the scope of the invention to operate the absorber with concentrations of solid ammonium carbonate and ammonium bicarbonate present in the aqueous ammonia solution. However, in this embodiment of the invention, the slurry, i.e., the carbon dioxide-rich ammonia solution that includes solids, is additionally processed using separation means, such as, for example, a cyclone to concentrate the slurry to, for example, at least about 50 wt % of the carbon dioxide-rich ammonia solution.

The invention will now be described by way of example in more detail with reference to the accompanying FIG. 1 showing one embodiment of the method of the invention. Presented in FIG. 1 is a process flow schematic of a process 10 for treating a high-pressure hydrocarbon feed stream to yield a treated hydrocarbon gas stream and a concentrated carbon dioxide stream.

In process 10, a high-pressure hydrocarbon feed stream comprising, methane, a high carbon dioxide content, and hydrogen sulfide (for example, 78 vol % methane, 20 vol % carbon dioxide and 2 vol % hydrogen sulfide), is passed through conduit 20 into absorber 22. Absorber 22 defines an absorption zone and provides means for contacting the high-pressure hydrocarbon feed stream with chilled aqueous ammonia under high-pressure and low-temperature absorption conditions. Absorber 22 can comprise multiple absorption stages.

In absorber 22, which in this embodiment is operated in its top end at a pressure of about 6 barg or higher and a temperature of about 40° C. or lower, carbon dioxide and hydrogen sulfide are absorbed in a chilled aqueous ammonia solution containing about 15 wt % (for example, of from or about 13 wt % to or about 17 wt %) ammonia that is introduced into absorber 22 via conduit 24 at a temperature of about 10° C. or less. This results in the production of a clean treated hydrocarbon gas stream that emerges from absorber 22 through conduit 26, and a carbon dioxide-rich aqueous ammonia solution that exits absorber 22 through conduit 28. Depending on the design of absorber 22 and the number of stages, the carbon dioxide present in the treated gas stream will be reduced to less than 3 vol. %, preferably less than 2%, while the hydrogen sulfide in the treated gas will be reduced to less than 200 ppmv, and, preferably, to less than 100 ppmv.

The carbon dioxide-rich aqueous ammonia solution exiting absorber 22 through conduit 28 passes to cyclone 30 whereby any substantial solids present in the carbon dioxide-rich aqueous ammonia solution are separated therefrom and pass from cyclone 30 by way of conduit 32. In cases where only small amounts of solids are present in the solution, other ways of separating the solids, such as, the use of a filter (not shown), can be used instead of cyclone 30. To the extent the separated solids comprise ammonium carbonate or ammonium bicarbonate, they may be redissolved in water and recycled to absorber 22 in order to maintain an optimum concentration of these components in absorber 22.

The carbon dioxide-rich ammonia solution then passes from cyclone 30 through conduit 34 to pump 36, which provides means for imparting pressure head to increase the pressure of the stream of carbon dioxide-rich ammonia solution to at least about 42 barg. The carbon dioxide-rich ammonia solution then passes through heat exchanger 38 whereby it picks up heat from the lean aqueous ammonia solution by means of indirect heat exchange, and, thereafter, the heated carbon dioxide-rich ammonia solution is introduced into stripping column 40. If desired, solids may be removed from the carbon dioxide-rich aqueous ammonia solution after heat exchanger 38, in which case cyclone 30 would be placed in conduit 34 between heat exchanger 38 and stripping column 40.

In stripping column 40, which in this embodiment within its top end is operated at a pressure of at least 40 barg and a temperature of at least 120° C., the carbon dioxide and hydrogen sulfide that are absorbed in the aqueous ammonia solution to provide the carbon dioxide-rich ammonia solution are stripped therefrom to produce a concentrated carbon dioxide-rich gas stream.

The concentrated carbon dioxide-rich gas stream is removed from the upper part of stripping column 40 through conduit 42 and is at a high pressure suitable for sequestration. It is significant that the concentrated stream of carbon dioxide that passes from stripping column 40 by way of conduit 42 can be under such a high pressure that there is no need to employ a compressor to pressurize this stream in order to provide for its sequestration or other high pressure use.

Lean aqueous ammonia solution is removed from the bottom of stripping column 40 though conduit 44 and passes through heat exchanger 38 by which it exchanges heat through indirect heat exchange with the carbon dioxide-rich ammonia solution and, further, to chiller 46 before being returned as a recycle to absorber 22 via conduit 24. Chiller 46 provides means for removing additional heat from the lean aqueous ammonia solution in order to cool it to the low or reduced temperature required for the operation of absorber 22. Heat is provided to stripping column 40 by means of reboiler 50.

Various changes and modifications may be made to the aforedescribed embodiments of the invention without departing from the spirit of the invention. Such obvious variations and modifications are considered to be within the proper scope of this invention.

That which is claimed is:

1. A method of treating a high-pressure hydrocarbon stream, comprising a high concentration of carbon dioxide, to remove therefrom carbon dioxide to yield a treated hydrocarbon gas stream and a concentrated stream of carbon dioxide, wherein said method comprises:
contacting said high-pressure hydrocarbon stream with a chilled aqueous ammonia solution in an absorber at a high pressure to yield said treated hydrocarbon gas stream and a carbon dioxide- rich ammonia solution; and
stripping carbon dioxide from said carbon dioxide-rich ammonia solution in a stripping column at a high pressure to yield a lean ammonia solution and said concentrated stream of carbon dioxide at high pressure.

2. The method as recited in claim 1, wherein said high-pressure hydrocarbon gas stream comprises natural gas or synthetic gas containing from 5 vol % to 80 vol % carbon dioxide.

3. The method as recited in claim 1, wherein said high-pressure hydrocarbon stream further comprises, other than said high concentration of carbon dioxide, a high concentration of hydrogen sulfide and a predominant concentration of a hydrocarbon gas selected from the group consisting of methane, ethane, propane, butane, pentane, and mixtures thereof.

4. The method as recited in claim 1, wherein the pressure in said absorber is between 5 barg and 40 barg.

5. The method as recited in claim 4, wherein the operating temperature in said absorber is between 5° C. and 60° C.

6. The method as recited in claim 5, wherein the temperature of said chilled ammonia solution which is contacted with said high-pressure hydrocarbon stream in said absorber is less than 20° C., and the concentration of ammonia in said chilled aqueous ammonia solution is from 1 wt % to 50 wt %.

7. The method as recited in claim 6, wherein said carbon dioxide-rich ammonia solution that is passed as feed to said stripping column and said lean ammonia solution which is recycled to said absorber are both in liquid phase with no substantial solids present.

8. The method of claim 7, wherein the pressure in said absorber is between 10 barg and 20 barg, and the concentration of ammonia in said chilled aqueous ammonia solution is from 10 wt % to 20 wt %.

9. The method as recited in claim 1, wherein said stripping column is operated under high pressure conditions so as to yield a concentrated stream of carbon dioxide suitable for sequestration or other commercial uses.

10. The method as recited in claim 8, wherein the pressure in said stripping column is between 20 barg and 100 barg, and the operating temperature in said stripping column is between 40° C. and 180° C.

11. The method as recited in claim 10, wherein said lean ammonia solution is cooled to provide said chilled ammonia solution having a temperature of from 5° C. to 20° C.

12. The method as recited in claim 1, wherein said carbon dioxide rich ammonia solution leaving the absorber has a concentration of solids, and wherein said method further comprises removing solids from said carbon dioxide rich ammonia solution prior to introduction into said stripping column.

13. The method of as recited in 3, wherein said concentration of hydrogen sulfide is in the range of from 1 vol % to 20 vol. % and the predominant concentration of said hydrocarbon gas is from 20 vol % to 90 vol %.

14. The method as recited in claim 1, wherein heat energy is exchanged by indirect heat exchange between said carbon dioxide-rich ammonia solution and said lean ammonia solution to provide a heated carbon dioxide-rich ammonia solution that is passed as feed to said stripping column and a cooled lean ammonia solution that is recycled to said absorber.

15. The method as recited in claim 11, wherein said treated hydrocarbon gas stream comprises less than 3 vol. % carbon dioxide and less than 200 ppmv hydrogen sulfide.

16. The method as recited in claim 11, wherein the temperature of said chilled ammonia solution that is contacted with said high-pressure hydrocarbon gas stream in said absorber is less than 15° C.

17. The method as recited in claim 9, wherein said concentrated stream of carbon dioxide comprises more than 90 vol % carbon dioxide.

18. The method as recited in claim 10, wherein the pressure in said stripping column is between 25 barg and 50 barg, and the operating temperature in said stripping column is between 80° C. and 120° C.

19. The method as recited in claim 18, wherein the temperature of said chilled ammonia solution that is contacted with said high-pressure hydrocarbon gas stream in said absorber is between 5° C. and 10° C.

20. The method as recited in claim 19, wherein said treated hydrocarbon gas stream comprises less than 2 vol. % carbon dioxide and less than 100 ppmv hydrogen sulfide.

21. The method as recited in claim 2, wherein said high-pressure hydrocarbon gas stream comprises natural gas containing from 10 vol % to 40 vol % carbon dioxide.

22. The method as recited in claim 17, wherein said concentrated stream of carbon dioxide is at a pressure of 25 barg to 50 barg.
